(19) United States
(12) Patent Application Publication
(10) Pub. No.: US 2017/0086494 A1
(43) Pub. Date: Mar. 30, 2017

(54) Printing on liquid medium with a membrane

(71) Applicants: Hue P. Le, Beaverton, OR (US); Tai Ngoc Dang, Porland, OR (US); Tue Nguyen, Fremont, CA (US)

(72) Inventors: Hue P. Le, Beaverton, OR (US); Tai Ngoc Dang, Porland, OR (US); Tue Nguyen, Fremont, CA (US)

(21) Appl. No.: 15/049,125

(22) Filed: Feb. 21, 2016

Related U.S. Application Data
(63) Continuation-in-part of application No. 14/867,005, filed on Sep. 28, 2015.
Application No. 14/867,005 is a continuation-in-part of application No. 15/044,100, filed on Feb. 15, 2016.

(51) Int. Cl. A23P 20/15

(52) U.S. Cl. CPC A23P 20/15; A23V 2002/00; A23P 2020/253

(57) ABSTRACT

Ink jet printing on a liquid medium can be performed using a membrane underlayer. A drop of a liquid can spread on the surface of the liquid medium, forming a substrate for the ink jet printing. The liquid ink can include a thermogelling component which can gelled, e.g., forming gel droplets, when contacting the membrane.

The present application is a continuation-in-part of application Ser. No. 14/867,005, filed on Sep. 28, 2015, entitle: “Printing on liquid medium using liquid ink” (HTT001), which is hereby incorporated by reference in its entirety.

The present application is a continuation-in-part of application Ser. No. 15/044,100, filed on Feb. 15, 2016, entitle: “Bordering image in liquid printing process” (HTT002), which is hereby incorporated by reference in its entirety.

### BACKGROUND

Automated printers using edible inks have been developed for printing on food products, e.g., printing directly on the food products, or separately printing on a sheet and placing it on the food products. The printing process typically uses liquid ink on solid or semi-solid surface, e.g., non-liquid substrate, for example, a foam top surface of a liquid beverage, such as a foam milk portion of a coffee drink.

Direct printing of liquid ink on liquid surface can represent difficulty, for example, since the liquid ink can disperse rapidly upon reaching the liquid substrate, distorting the printed image. For example, an inherent problem associated with aqueous inks employed in liquid printing, e.g., printing a liquid ink on a liquid medium, is the dispersion of ink drops after placement onto the liquid substrate. Dispersing can cause intercolor bleeding, poor resolution, and image degradation adversely affecting the print quality.

FIGS. 1A-1C illustrate a dispersion characteristic of a liquid ink on a liquid substrate according to some embodiments. In FIGS. 1A and 1B, a liquid droplet 120 can be dropped on a liquid substrate 110, for example, from an ink jet printer. As time progresses, the droplet 120 can disperse 130 in the liquid substrate, e.g., becoming larger and more diluted droplets 122, 124, and 126.

In FIG. 1C, a liquid droplet 125 can be dropped on a foam surface 114 of a liquid substrate 112. The liquid droplet 125 can be confined by the foam surface, thus allowing printing of liquid ink, e.g., minimizing the dispersion of the ink.

Thus there is a need for printing of liquid ink on a liquid substrate with minimal dispersion.

### SUMMARY

In some embodiments, the present invention discloses methods and systems for printing an image on a liquid medium with a membrane underlayer. A membrane can be a film formed on a surface of the liquid medium, such as by spreading a drop of liquid on the liquid medium surface. For example, a membrane can be an oily film formed on the surface of water, by spreading a drop of oil. A liquid ink then can be used for printing on the membrane. The liquid ink can include a thermogelling component which can gelled, e.g., forming gel droplets, when contacting the membrane.

In some embodiments, the present invention discloses methods and systems for printing an image on a liquid medium together with a membrane barrier. The methods can use a liquid ink that gels when contacting the liquid. The membrane can be formed by dropping a drop of liquid on a surface of the liquid medium. The membrane barrier can prevent or reduce the gel dots at the edges of the image from being dispersed, allowing the formation of a high resolution image on the liquid. The membrane barrier can be disposed on external and internal areas of the image. The membrane barrier can be disposed on the image.

### BRIEF DESCRIPTION OF THE DRAWINGS

FIGS. 1A-1C illustrate a dispersion characteristic of a liquid ink on a liquid substrate according to some embodiments.

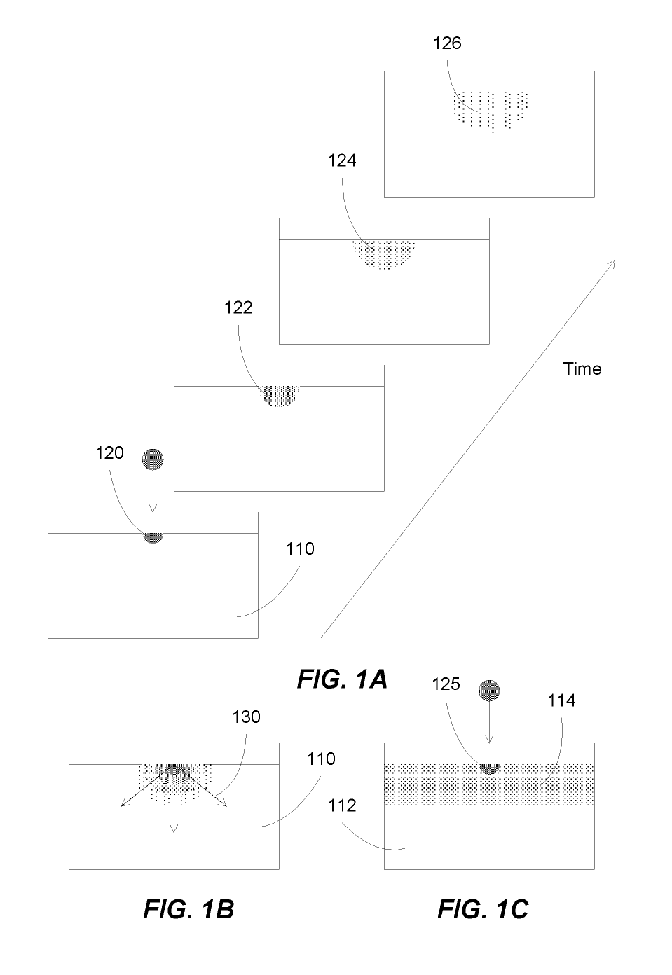

FIGS. 2A-2E illustrate printing on membrane of a liquid medium according to some embodiments.

FIGS. 3A-3C illustrate flow charts for liquid printing according to some embodiments.

FIGS. 4A-4D illustrate border membrane processes according to some embodiments.

FIGS. 5A-5C illustrate flow charts for liquid printing according to some embodiments.

FIGS. 6A-6C illustrate processes to form membranes over printed images according to some embodiments.

FIGS. 7A-7B illustrate flow charts for liquid printing according to some embodiments.

FIGS. 8A-8B illustrate a print head having a membrane printing assembly according to some embodiments.

FIG. 9 illustrates a schematic of a printer for printing on a liquid according to some embodiments.

### DETAILED DESCRIPTION OF THE EMBODIMENTS

In some embodiments, the present invention discloses methods and systems for automated printing on liquid substrates, such as liquid beverages, using liquid ink, such as edible liquid ink.

In some embodiments, the present invention discloses methods and systems for forming a membrane of a surface of a liquid, with the membrane assisted in forming a base for printing images, e.g., the images can be printed on the membrane with reduced or minimal image distortion, for example, due to ink pixel diffusion. The ink can be printed on top of the membrane. The ink can be printed penetrating the membrane, e.g., all or a port of the ink droplets can be confined within the membrane, which can limit the diffusion of the ink droplets. In some embodiments, the ink can be a phase change ink, e.g., having a thermo-inversion gelling property, which can form gel droplets when contacting the membrane or the liquid.

The membrane can include a thin film of a non-mixable and lighter liquid, as compared to the liquid medium. The membrane can be thin, such as less than 1 mm thickness, less than 100 microns thickness, less than 10 micron thickness, or less than 1 micron thickness. The membrane can include a liquid material that is unmixable with the liquid medium, thus can form a separate membrane. The membrane can include a liquid material that is lighter than the liquid medium, thus can be formed on a top surface of the liquid medium.

In some embodiments, the liquid medium can include water, e.g., a water based liquid. The membrane can include an oily film, which can cover the surface of the water based liquid. The membrane can include a liquid material having sulfate ions (SO₄⁻) or selenate ions (SeO₄⁻), or an alkaline component, which can form a thin film on a water based liquid surface.

In some embodiments, the membrane can be formed by supplying one or more drops of a liquid material on the liquid medium surface. The membrane liquid material can include an unmixable and lighter liquid than the liquid medium, such as an oil-based liquid or a sulfate or selenate ion based liquid for used on a water based liquid medium. The drops of the membrane liquid can be spread upon contacting the liquid medium, forming a membrane on the liquid medium.

In some embodiments, the membrane can have a clear color or a color of the liquid medium, which does not interfere with the image printed on the membrane. The membrane can have different colors, e.g., one color membrane or multi-color membrane. The membrane colors can be configured to emphasize or de-emphasize the image. For example, the image can have a light color or a clear color, and the membrane can include a dark color, such as block or blue.

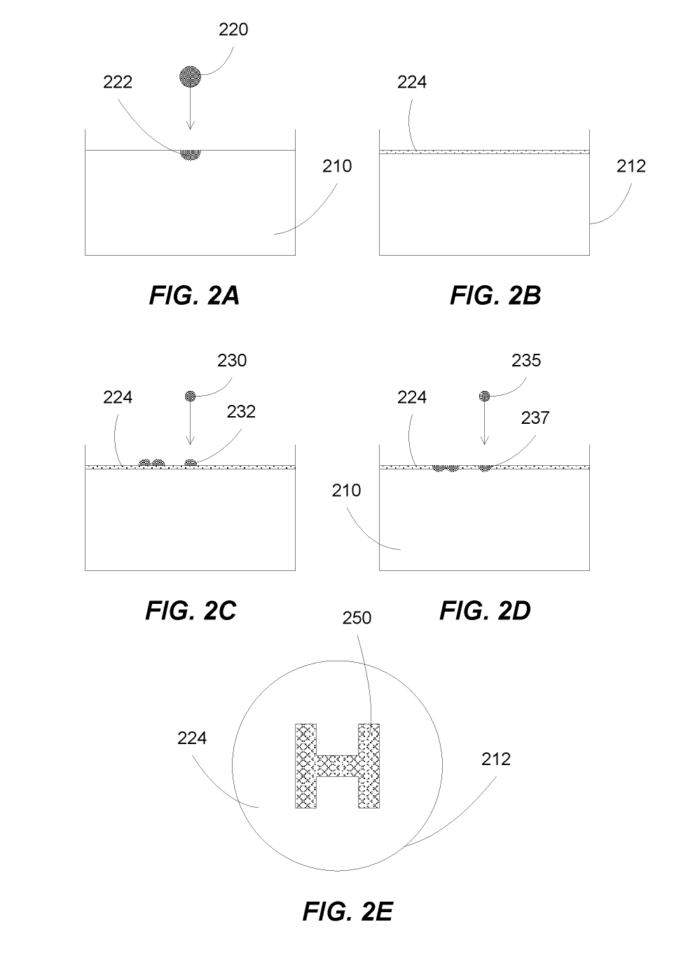

FIGS. 2A-2E illustrate printing on membrane of a liquid medium according to some embodiments. In FIG. 2A, a container 212 can include a liquid 210, which can be a liquid medium for printing. A membrane liquid 220 can be provided, e.g., dropping, on the liquid medium 210, forming a droplet 222. In FIG. 2B, the membrane droplet 222 can spread out to form a thin film, e.g., a membrane 224 on the surface of the liquid medium. In FIG. 2C, a printer head, such as an ink jet print head, can be used to deliver ink droplets 230. The ink droplets can be disposed on top of the membrane 224. Multiple ink droplets 232 can be arranged to form an image, for example, by a controller controlling the print head to deliver the ink droplets at right locations.

FIG. 2D shows an alternate configuration in which a printer head can be used to deliver ink droplets 235. The ink droplets 237 can penetrate the membrane 224, for example, to form an image. As shown, a portion of the ink droplets 237 can pass through the membrane 224 and contact the liquid medium 210. Alternatively, the ink droplets can be confined within the membrane, and/or can be exposed to the air ambient on top of the membrane.

FIG. 2E shows a top view of the container 212, showing the printed image 250 on the membrane 224 on the liquid medium 210 (not shown, e.g., under the membrane 224).

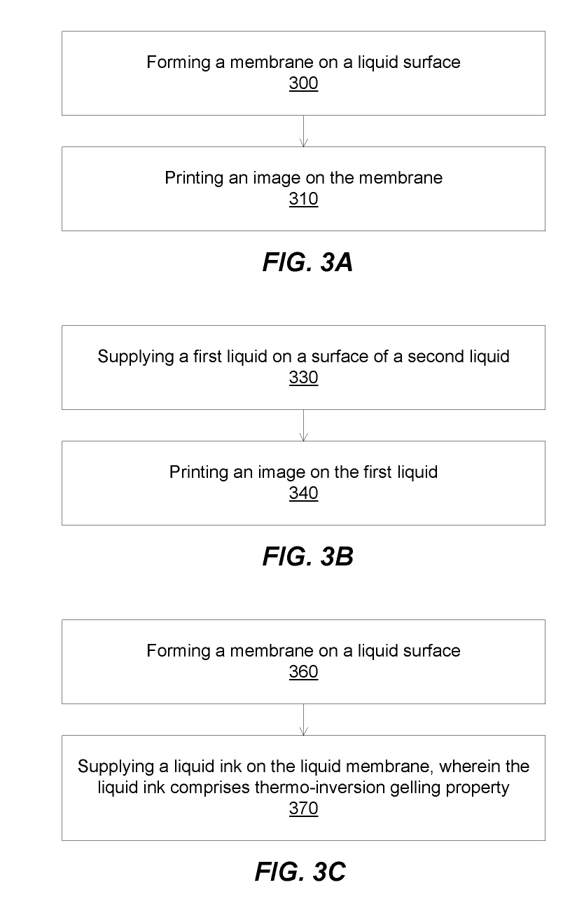

FIGS. 3A-3C illustrate flow charts for liquid printing according to some embodiments. In FIG. 3A, operation 300 forms a membrane on a liquid surface. Operation 310 prints an image on the membrane. The printed image can be on top of the membrane. The printed image can totally or partially penetrate the membrane. The printed image can reach the liquid medium. The membrane can be used to confine the image, such as the ink droplets forming the image can be constrained by the membrane.

In FIG. 3B, operation 330 supplies a first liquid on a surface of a second liquid. The first liquid can be placed in a pipette, and then drop on the second liquid. The drop of the first liquid can spread to form a membrane on the second liquid. Operation 340 prints an image on the first liquid.

In FIG. 3C, operation 360 forms a membrane on a liquid surface. Operation 370 supplies a liquid ink on the liquid membrane, wherein the liquid ink comprises thermo-inversion gelling property.

In some embodiments, the liquid ink can include a thermogelling component, e.g., a component having a thermo-inversion gelling property, which can cause the liquid ink to gel when reaching a gelling temperature, e.g., a temperature higher or lower than the temperature of the liquid ink and at which temperature, the liquid ink changes from a liquid phase to a gel phase. For example, the liquid ink can include a hyperthermogelling component, which can cause the liquid ink to gel at a certain temperature (e.g., a gelling temperature) or at temperatures higher than the gelling temperature. For example, the liquid ink can be a liquid at room temperature, e.g., 25 C, and can have a gelling temperature of 50 C, e.g., the liquid ink can gel at and above 50 C. The liquid ink can be ink jet printed on a hot liquid with the temperature of the liquid greater than the gelling temperature of the liquid ink, for example, higher than 50 C. Upon contacting the hot surface, the liquid ink can gel, e.g., the viscosity of the liquid ink can change significantly from a liquid-like ink to a gel-like ink.

Alternatively, the liquid ink can include a different thermogelling component, which can cause the liquid ink to gel at temperatures lower than the temperature of the liquid ink. For example, the liquid ink can be a liquid at room temperature, e.g., 25 C, and can have a gelling temperature at 10 C, e.g., the liquid ink can gel at and below 10 C. The liquid ink can be ink jet printed on a cold or cool liquid, e.g., having temperature lower than 10 C, such as at 0 C. Upon contacting the cold or cool surface, the liquid ink can gel, e.g., the viscosity of the liquid ink can change significantly from a liquid-like ink to a gel-like ink.

The gelled ink can resist against liquid dispersion, allowing the formation of a high resolution image on the liquid substrate. The printing process can be performed using an automated printer having a movable printer head, such as an ink jet printer head loaded with a liquid ink. The liquid ink can include a color agent.

In some embodiments, the present invention discloses liquid ink mixtures having thermogelling characteristics, e.g., having a thermo-inversion gelling property, and methods to print on liquid substrates using the liquid ink mixtures. The liquid ink mixtures can include an aqueous phase change ink, which can contain a selected concentration of a thermogelling components, which can cause the ink to gel when its temperature is increased above or decreased below its thermo-inversion point. The ink may be jetted directly onto a heated liquid. The thermo-inversion point can be above the ambient temperature, such as the temperature of a hot beverage, e.g., between 50 and 100 C. The thermo-inversion point can be below the ambient temperature, such as the temperature of a cold or cool beverage, e.g., between 20 and 0 C.

The phase change inks can exist in the liquid phase in an ink jet printing device. In operation, droplets of liquid ink can be ejected from the printing device. When the ink droplets contact the surface of the liquid medium, they can quickly solidify, e.g., converting to a gel state, to form a pattern of solidified, e.g., gelled, ink dots.

In some embodiments, the gelling action can occur quickly, e.g., in less than 1 second, such as less than 500 msec, less than 200 msec, less than 100 msec, or less than 50 msec. The ink droplets can have a small dimension, such as less than 100 microns, less than 75 microns, less than 50 micron, or less than 25 microns. The small dimension of the ink droplets can provide high resolution images on the liquid substrate, together with low dispersion due to the fast gelling time caused by the small sizes of the ink droplets.

In some embodiments, an ink jet print head can jet liquid ink droplets on a liquid substrate. The temperature of the liquid substrate can be different than a temperature of the liquid ink. The temperature of the liquid substrate can be configured so that the liquid ink droplet can gel to form gel droplets. The gelling process can include a solidification process, converting the liquid ink droplets into solid, e.g., non-liquid, droplets. The gelling process can include a phase change process, converting the liquid ink droplets into non-liquid droplets, e.g., changing the ink droplets from a liquid phase to a non-liquid phase such as a solid, jelly-like material.

An image can be processed and sent to the ink jet print head. The ink jet print head can then print the image on the surface of the liquid substrate. The image can include a collection of gel droplets, placing adjacent each other. Since the droplets are gel droplets, there can be minimal or no diffusion of the droplets, e.g., there is no enlargement of the droplets, or the droplet size can remain constant.

In some embodiments, the phase change liquid ink can be used for printing on a membrane on a liquid medium. For example, a membrane can be formed on a liquid medium, such as using a drop of oil-based liquid or sulfate ion based liquid on the liquid medium surface, and allowing the drop to spread to form a thin film. An ink jet print head having a phase change liquid ink can be used to print an image on the membrane. Due to the thermo-inversion gelling property of the phase change liquid ink, the liquid ink droplets can be converted to gel droplets when contacting the membrane and/or the liquid medium. The gel droplets can have less diffusion as compared to liquid droplets. In addition, since the gel ink droplets can be disposed on top of the membrane, or can be partially or fully embedded in the membrane, the membrane can assist in confining the gel ink droplets, which can further reduce distortion of the image due to movements of the ink droplets, especially at the borders of the image. For example, without the membrane, the border gel droplets can migrate, diffusing outward. The diffusion can disperse the border droplets, causing distortion of the image, especially at the borders, e.g., edges of the images. The diffusion can be space and time related, e.g., the border droplets can migrate outward first before the inner droplets can move. The membrane can constrain the border droplets, as well as the inner droplets, to reduce or prevent movements of the droplets.

In some embodiments, after printing the image, additional membrane can be added, for example, over the image, over the surface areas of the liquid medium not covered by the image, and/or over the whole surface of the liquid medium (e.g., over the image and over the surface areas of the liquid medium not covered by the image). The additional membrane can further assist in confining the border ink droplets, which can further reduce image distortion.

In some embodiments, the present invention discloses methods and systems for printing aqueous inks on liquid substances with reduced image degradation. A barrier can be formed at edges or borders of a printed image, e.g., at non-printed locations adjacent to printed locations. The barrier can confine the image in place, preventing the ink at the edges or borders from diffusing outward.

An aqueous or liquid inks can be used to print images on a liquid substrate, e.g., on a surface of a liquid contained in a container. The aqueous or liquid inks can include phase change inks, which can contain containing liquid soluble compounds that exhibit thermo-inversion properties, e.g., compounds whose liquid solubility decreases as the solution temperature changes. Thus, when droplet ink solutions of these compounds are heated or cooled to their thermo-inversion points, they exhibit thermogelling properties in which these compounds undergo a phase transition to turn the ink droplets into discrete, stable gels, e.g., ink gels.

An image can be formed, e.g., printed, on a liquid medium, using phase change inks that gel instantly on contact with a different temperature liquid substrate, e.g., a liquid medium having a higher or lower temperature than that of the phase change liquid ink. The inks can be gelled instantly, e.g., turning into jelly-like droplets, which can keep the sizes and shapes to form high resolution images that do not become blurred due to ink diffusion.

In some embodiments, the present invention discloses methods and systems to minimize the diffusion of the printed images, such as limiting the movements of the jelly-like droplets that form the edges of the images on or in the liquid medium. The ink droplets at in interior portion of the image can have neighbor droplets at all surrounding sites, which can confine the movements of the ink droplets.

In contrast, the ink droplets at edges or borders of the images can have neighbor droplets at one or more adjacent sides, e.g., not completely surrounded by neighbor droplets, and can face the liquid medium at least one side. Thus the ink droplets at the edges or borders of the images are not constrained at the sides facing the liquid medium, and therefore can diffuse toward the liquid medium, e.g., move in a random motion due to thermal or liquid agitation, which can result in distortions of the images.

In some embodiments, barriers can be formed at the edges of borders of a printed image. The barriers can block movements of the ink droplets, e.g., the ink droplets at the edges or at the borders can now be confined in all directions. For example, a barrier can be formed by providing a membrane around the image. The barrier formation can include membranes in exterior and interior edges and borders of the image.

In some embodiments, the present invention discloses a method for printing an image on a liquid medium having reduced edge distortion. The method can include printing the image on the liquid medium, together with forming a barrier around the image. The barrier is configured to confine the image.

In some embodiments, the barrier can include membranes, e.g., the barrier can be formed by supplying a membrane liquid, such as dripping one or more membrane liquid drops, on the areas of the liquid medium that are outside of the external borders of the image and/or inside of the internal borders of the image. The membrane liquid drops can have a clear color, or a color similar to the liquid medium, and thus do not interfere with the image presentation. The membrane liquid drops can disperse or spread to cover the liquid areas not covered by the image.

In some embodiments, the present invention discloses methods and systems to reduce edge distortion of image printed on liquid surface, by forming membranes at a border, interior border or exterior border, around the image.

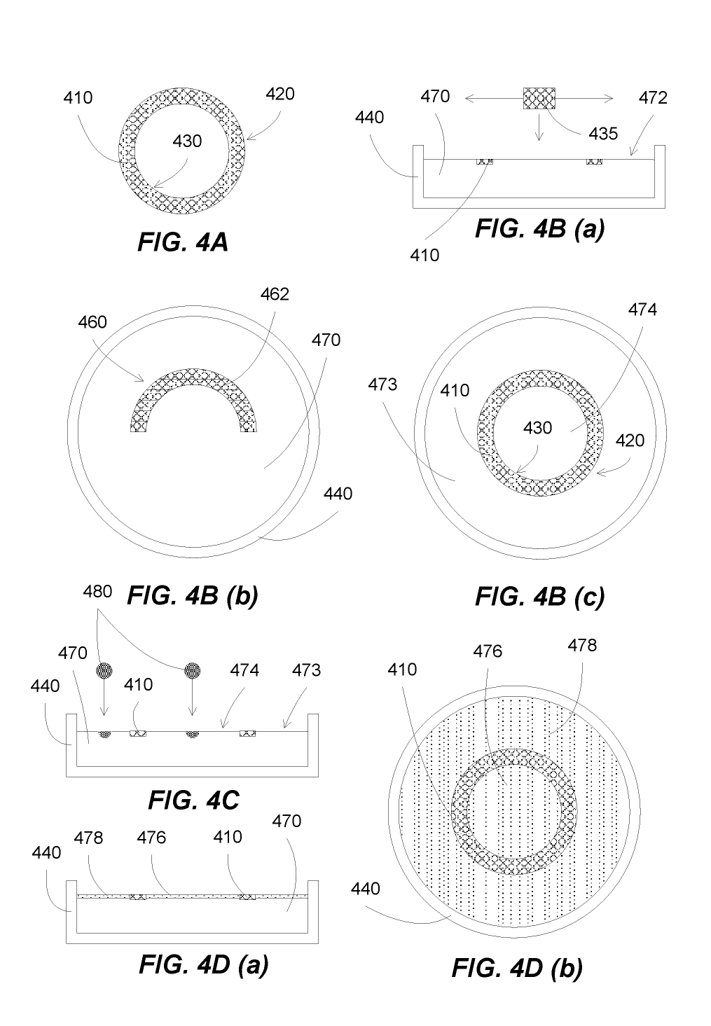

FIGS. 4A-4D illustrate border membrane processes according to some embodiments. An ink jet print head can print an image on the surface of the liquid substrate. Membranes can be formed outside of external borders or edges, and inside of internal borders or edges.

In FIG. 4A, an image 410 can be prepared. The image can have external borders or edges 420, and internal borders or edges 430.

In FIG. 4B (a)-(c), a printer 435 can print the image 410 on a surface 472 of a liquid medium 470. FIG. 4B (a) shows a cross section of a printing set up, including a container 440 containing the liquid medium 470, A printer 435 can be positioned above the surface of the liquid medium 470. The printer can receive the image 410, for example, from a controller, which can control the movements of a print head to jet ink droplets on the liquid medium at locations to form the image 410.

FIG. 4B (b) and (c) show top views of the printing set up, with a time difference between the figures. For example, FIG. 4B (b) can show a middle of the printing process, showing a portion of the printed image, and FIG. 4B (c) can show an end of the printing process, showing a complete image.

The print head can raster back and forth to print the image, e.g., the image can include multiple rastered lines. In a typical rastered line 460, a portion 462 of the image can be printed. There can be portions 473 and 474 of the liquid surface 472 that are not covered by the image 410. For example, there can be areas 474 of the liquid surface 472 that are outside of the external border 420 of the image 410. There can be areas 473 of the liquid surface 472 that are inside of the internal border 430 of the image 410.

FIG. 4C shows a process to form membranes on the non-printed surface of the liquid medium. A membrane liquid 480 can be dripped on non-printed areas of the liquid surface, such as on areas 473 of the liquid surface 472 that are inside of the internal border 430 of the image 410, and/or on areas 474 of the liquid surface 472 that are outside of the external border 420 of the image 410.

FIG. 4D (a)-(b) show a formation of membranes as a barrier to limit the distortion of the image 410. The drops of membrane liquid 480 can be spread on the surface of the liquid medium, until reaching the container and the borders, internal and external, of the image. The spreading of the membrane liquid can form membranes 476 and 478, which can limit the movements of the border or edge gel ink droplets in the image 410.

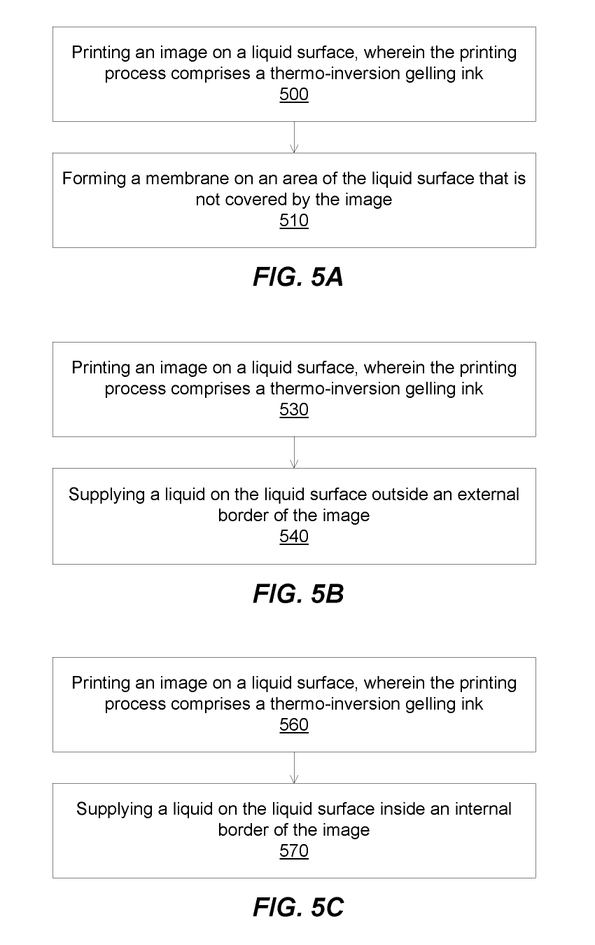

FIGS. 5A-5C illustrate flow charts for liquid printing according to some embodiments. In FIG. 5A, operation 500 prints an image on a liquid surface, wherein the printing process comprises a thermo-inversion gelling ink. Operation 510 forms a membrane on an area of the liquid surface that is not covered by the image. The membrane can be formed by dripping drops of a membrane liquid on the liquid medium. The membrane can be used to confine the image, such as the ink droplets forming the image can be constrained by the membrane. The membrane can be configured to form a barrier to confine the image.

In FIG. 5B, operation 530 prints an image on a liquid surface, wherein the printing process comprises a thermo-inversion gelling ink. Operation 540 supplies a membrane liquid on the liquid surface outside an external border of the image. The membrane liquid can be placed in a pipette, and then drop on the liquid. The drop of the membrane liquid can spread to form a membrane on the liquid.

In FIG. 5C, operation 560 prints an image on a liquid surface, wherein the printing process comprises a thermo-inversion gelling ink. Operation 570 supplies a liquid on the liquid surface inside an internal border of the image.

In some embodiments, the membrane can be formed with a selected color, e.g., the color of the membrane liquid can be the selected color. For example, the membrane can be formed with a clear color, e.g., using transparent color membrane liquid, so that the color of the membrane can be the color of the background, e.g., the color of the canvas or the color of the liquid medium. The membrane can be formed with a color of the liquid medium, e.g., the color of the liquid portion adjacent to the image. If the liquid medium has a uniform color, then the membrane can be formed using that uniform color. If the liquid medium has different colors at different areas, then the membrane can be formed using the color of the area near the image. The membrane can be formed with a color to emphasize or de-emphasize the image. The membrane can be formed with a light color, a contrast color, a phase out color, or a gradient color.

In some embodiments, a color of the membrane liquid can be selected before forming the membrane. For example, a color of the liquid medium can be determined, and the membrane liquid can be prepared to have the liquid medium color. The membrane liquid can be dripped on the liquid surface to form the membrane.

In some embodiments, the present invention discloses methods and systems to reduce edge distortion of image printed on liquid surface, by forming membranes over the image, including at borders around the image.

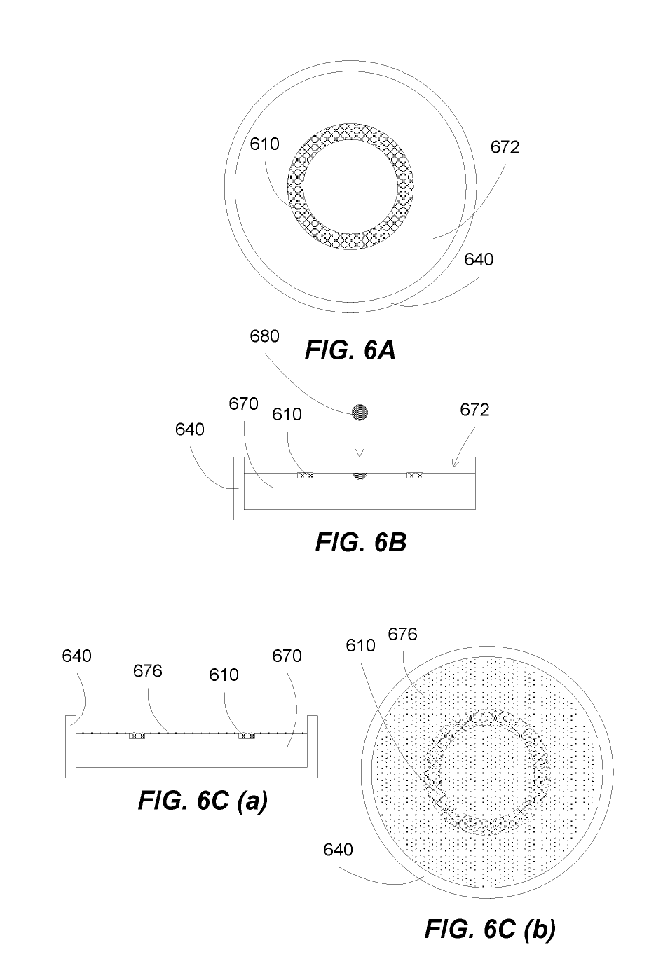

FIGS. 6A-6C illustrate processes to form membranes over printed images according to some embodiments. An ink jet print head can print an image on the surface of the liquid substrate. Membranes can be formed in the printed image, together with outside of external borders or edges, and inside of internal borders or edges.

In FIG. 6A, an image 610 can be printed on a surface 672 of a liquid medium 670. FIG. 6B (a) shows a cross section of a printing set up, including a container 640 containing the liquid medium 670, A printer can be positioned above the surface of the liquid medium 670. The printer can receive the image 610, for example, from a controller, which can control the movements of a print head to jet ink droplets on the liquid medium at locations to form the image 610.

FIG. 6B shows a process to form a membrane on the surface of the liquid medium. A membrane liquid 680 can be dripped on an area of the liquid surface. The membrane liquid can be provided on more than one areas, such as on the image area, or on non-printed areas, such as on areas of the liquid surface that are inside of the internal border of the image, and/or on areas of the liquid surface that are outside of the external border of the image.

FIG. 6C (a)-(b) show a formation of membranes as a barrier to limit the distortion of the image 610. The drops of membrane liquid 680 can be spread on the surface of the liquid medium, until reaching the container and the borders, internal and external, of the image. The spreading of the membrane liquid can form membranes 676, which can limit the movements of the border or edge gel ink droplets in the image 610. The membrane 676 can cover the image and non-printed liquid surface areas.

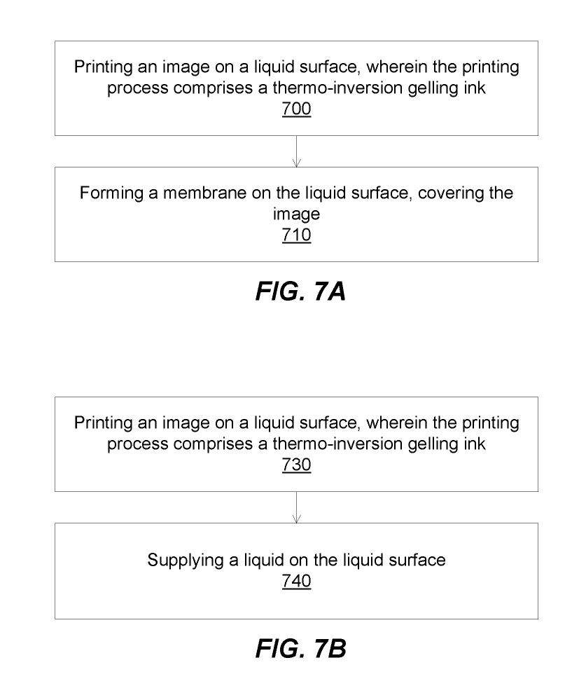

FIGS. 7A-7B illustrate flow charts for liquid printing according to some embodiments. In FIG. 7A, operation 700 prints an image on a liquid surface, wherein the printing process comprises a thermo-inversion gelling ink. Operation 710 forms a membrane on the liquid surface. The membrane can cover the image. The membrane can be formed by dripping drops of a membrane liquid on the liquid medium. The membrane can be used to confine the image, such as the ink droplets forming the image can be constrained by the membrane. The membrane can be configured to form a barrier to confine the image.

In FIG. 7B, operation 730 prints an image on a liquid surface, wherein the printing process comprises a thermo-inversion gelling ink. Operation 740 supplies a membrane liquid on an exposed area of the liquid surface or on the image. The membrane liquid can be placed in a pipette, and then drop on the liquid. The drop of the membrane liquid can spread to form a membrane on the liquid.

In some embodiments, the present invention discloses printer heads for printing on liquid substrates. A printer head can have at least one ink head portion, with the at least one ink head portion configured to accept a membrane liquid, e.g., a liquid that can form a membrane on another liquid medium, such as an oil-based liquid or a sulfate or selenate based liquid for forming membranes on a water based liquid. For example, a printer head can have one row of nozzles, with the row configured to be coupled to an ink reservoir. The row of nozzles can be configured to accept a membrane liquid. The printer head can be used to print membrane droplets, e.g., to print droplets on a liquid substrate that can spread to form a membrane.

A printer head can have 2 rows of nozzles, with each row configured to be coupled to an ink reservoir. One row of nozzles can be configured to accept a membrane liquid. The other row can be configured to accept a color ink, such as black ink or other color inks.

A printer head can have nozzles partitioned into two or more portions, such as 4 portions of nozzles, with different portions configured to be coupled to different ink reservoirs. One portion of nozzles can be configured to accept a membrane liquid. The other portions can be configured to accept different color inks, such as cyan, magenta, and yellow for 4 portion printer heads, or cyan, magenta, yellow, and black for 5 portion printer heads.

In some embodiments, a printer head can include a 2 portion printer head, with one portion configured to be coupled to a membrane liquid reservoir. The other portion can be configured to be coupled to a black color ink reservoir. Other color, instead of black, can be used.

In some embodiments, a printer head can include a 4 portion printer head, with one portion configured to be coupled to a membrane liquid reservoir. The other portions can be configured to be coupled to cyan, magenta, and yellow color ink reservoirs. Other colors, instead of cyan, magenta, and yellow, can be used.

In some embodiments, a printer head can include a 5 portion printer head, with one portion configured to be coupled to a membrane liquid reservoir. The other portions can be configured to be coupled to cyan, magenta, yellow, and black color ink reservoirs. Other colors, instead of cyan, magenta, yellow, and black, can be used.

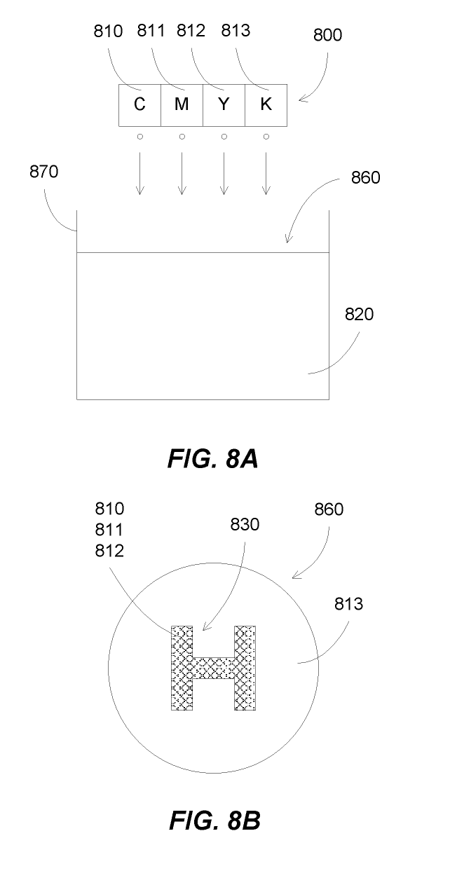

FIGS. 8A-8B illustrate a print head having a membrane printing assembly according to some embodiments. A print head 800 can have multiple nozzles configured to deliver, such as jetting droplets due to thermal energy or due to piezo action. The nozzles can be coupled to a membrane liquid ink delivery assembly. The nozzles can be partitioned into 2 or more portions, with different portions coupled to different liquid ink delivery assemblies, with the material of one liquid ink in at least one liquid delivery of the liquid deliveries being a membrane liquid, e.g., configured to form a membrane when reaching a liquid medium, such as a water based liquid.

As shown, the print head 800 is partitioned into 4 portions, with one portion 810 connected to a color ink of cyan, one portion 811 connected to a color ink of magenta, one portion 812 connected to a color ink of yellow, and one portion 813 connected to a membrane liquid for forming membranes on water based liquid media. The three color inks of cyan, magenta, and yellow can be used to print an image 830 on a surface 860 of a liquid 820 contained in a liquid container 870. The membrane liquid can be used to print, e.g., form, membranes, e.g., areas outside the external borders or external edges, areas inside the internal borders or internal edges of the image, and optionally areas on the image.

In some embodiments, the present invention discloses printers, and methods to use the printers, to print liquid inks on liquid surfaces. The printers can include ink jet printers, which can deposit droplets of liquid on a substrate.

Ink jet printers can include an ink supply for supplying inks to a nozzle head, at which the ink drops are ejected. Ink drop ejection can be controlled by an actuator, such as a piezo actuator or a thermal actuator. A piezoelectric actuator can include a piezoelectric material, which bends in response to an applied voltage. The bending of the piezoelectric layer pressurizes the ink to leave the nozzle head. A thermal actuator can include a resistor, which can be heated when a voltage or current is applied. The thermal energy generated by the heated resistor can pressurize the ink to leave the nozzle head.

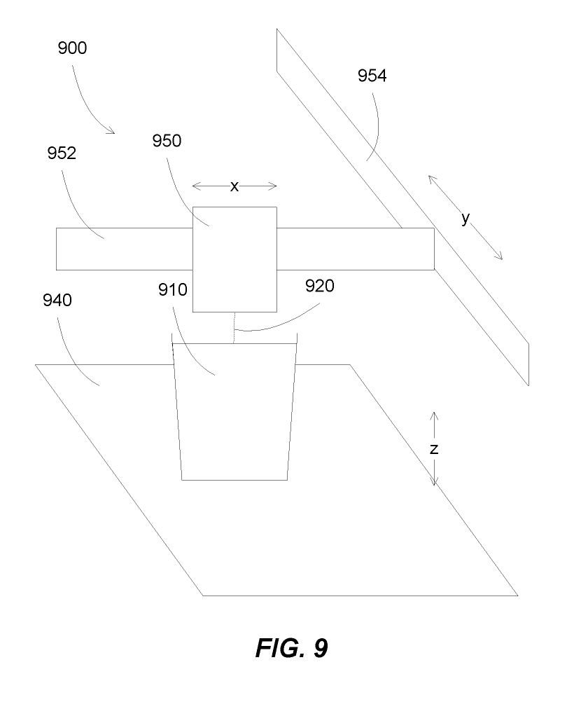

FIG. 9 illustrates a schematic of a printer for printing on a liquid according to some embodiments. The printer 900 can include a platform 940 for supporting a liquid container 910. The platform 940 can move in a z direction, for example, up and down, to bring the liquid container 910 closer to a printer head 950. In some embodiments, the platform can move so that the top surface of the liquid container is less than 10 mm or less than 5 mm from a bottom surface of the printer head 950. The printer head 950 can move in lateral directions, such as x and y directions. For example, a moving mechanism 952 can be configured to move the printer head 950 in the x direction. A moving mechanism 954 can be configured to move the printer head, e.g., through moving the mechanism 952, in the y direction. Other moving mechanisms can be used, such as a x-y table configured to move the printer head. In addition, the platform can be stationary, with the printer head moves in the z direction. A controller can be included to move the printer head according to a pattern for printing on the liquid surface. Other components can be included, such as ink reservoirs for different color inks. The printer can be loaded with thermogelling phase change liquid ink.

In operation, printer reservoirs containing liquid inks are connected to the printer head in the printer. A liquid container can be placed on the platform. The liquid can be at a temperature suitable for the printer ink, e.g., higher than the gelling temperature of the printer ink. If the temperature of the liquid is not suitable, the printer reservoirs can be replaced with other printer reservoirs that are suitable for the liquid on the platform. The temperature of the printer reservoirs can be controlled, so that it is lower than the temperature of the liquid.

The platform can move relative to the printer head so that the printer head is at a set distance from the liquid surface. The printer head can move according to a pattern to print on the liquid surface. Ink droplets 920 can be jetted to the liquid surface, and gelled instantly upon contacting the liquid.

A liquid container can be loaded to a platform, wherein the liquid container comprises a liquid. A height of the platform can be adjusted. A printer head can move to print a pattern on the liquid surface with a liquid ink, wherein the liquid ink gels when contacting the liquid, and wherein the pattern include an image and border elements bordering the image.

A liquid drink can be supplied on a platform of a printer system. An edible liquid ink can be printed on the liquid drink, wherein the liquid ink can include a thermogelling component, and a printed image can include border elements.

In some embodiments, the present invention discloses a printing process for printing an image using liquid phase change inks on liquid media. The phase change inks, in the form of ink droplets, can form gel droplets when contacting the liquid media. A liquid ink can be used. The liquid ink can have a thermo-inversion gelling property, e.g., the liquid ink can change phase, such as converting to a gel state from a liquid state, when subjected to a different temperature ambient, such as when contacting a liquid medium having a hotter or colder temperature. For example, a thermogelling component can be mixed with a solvent, such as water to form a liquid ink solution. Color agents can be added to the liquid ink solution to form a liquid ink having a thermo-inversion gelling property. The concentration of the thermogelling component can be based on the temperature of liquid substrate that the liquid ink will be printed upon. For example, the concentration of the thermogelling component in the liquid ink can be a concentration that the liquid ink can quickly gel upon contacting the liquid substrate, which can have a temperature different than the temperature of the liquid ink.

The liquid ink can be supplied in droplet forms to the liquid substrate. Since the concentration thermogelling component in the liquid ink is at concentration that allowing the liquid ink to gel at the temperature of the liquid substrate, when the liquid droplets contact the liquid substrate, the liquid droplets can form gel droplets.

In some embodiments, the phase change liquid ink can be used to print images on a liquid substrate. A liquid can be provided at a first temperature. The liquid can be contained in a container. The liquid can be a liquid drink, such as coffee, tea, or beer. The liquid can be heated or cooled to the first temperature. The liquid can be prepared using a hot liquid at a temperature higher than the first temperature, such as using hotter water for brewing a hot coffee drink or a hot tea drink. The liquid can be prepared using a heater system for heating the liquid. The liquid can be prepared using a cooling system for cooling the liquid, such as by refrigerating the liquid or by adding ice to the liquid.

A phase change liquid ink can be used to print on the liquid surface. The liquid ink can be an edible ink for used with a liquid drink. The liquid ink can be a thermogelling aqueous phase change ink at a critical concentration so that the liquid ink can turn into gel droplets upon contacting the liquid. For example, the liquid ink can have a thermo-inversion gelling property at a second temperature below the first temperature, thus when the liquid ink contacts the hot liquid, the liquid ink is subjected to an ambient having higher temperature than the gelling temperature of the liquid ink, and therefore converting to a gel state, e.g., forming gel droplets. The liquid ink can have a thermo-inversion gelling property at a second temperature above the first temperature, thus when the liquid ink contacts the cold liquid, the liquid ink is subjected to an ambient having lower temperature than the gelling temperature of the liquid ink, and therefore converting to a gel state, e.g., forming gel droplets.

In some embodiments, the present invention discloses edible inks having a thermogelling component, e.g., edible thermogelling aqueous phase change ink. The thermogelling aqueous phase change ink can include a nonionic surfactant, as disclosed in U.S. Pat. No. 5,462,591, which is incorporated by reference in its entirety, such as tetra-functional block copolymer surfactant terminating in primary hydroxyl groups such as ethylene oxide and propylene oxide, or an alkoxylated diamine. The nonionic surfactant can include a polyoxamine, having an alkyldiamine center (ethylene diamine, N—CH₂—CH₂—N), a hydrophobic core of y propylene oxide units, and hydrophilic end of x ethylene oxide units.

Numerous concentrations and combinations of these thermogelling components may be employed. A variety of other components that exhibit thermogelling properties may be used in ink compositions, such as homopolymers, copolymers, nonpolymeric or nonionic surfactants, naturally occurring polymers and their derivatives.

In some embodiments, the liquid ink drop may be jetted onto a liquid substrate that is warmer or cooler than the thermo-inversion point of the ink composition. Contact with the warm or cool liquid substrate can instantly gel the ink drop. For example, a hyperthermogelling ink composition can be formulated to have a thermo-inversion point at a temperature below 30, below 40, or below 50 C. Such an ink composition could be jetted as a liquid at room temperature and would gel instantly after contacting a hot drink, such as a hot coffee or a hot tea drink, which has a temperature higher than the thermo-inversion point. Similarly, a thermogelling ink composition can be formulated to have a thermo-inversion point at a temperature below 0, below 5, or below 10 C. Such an ink composition could be jetted as a liquid at room temperature and would gel instantly after contacting a cold drink, such as a cold beer or cold soft drink, which has a temperature lower than the thermo-inversion point.

Alternatively, a thermogelling ink composition can be formulated to have a thermo-inversion point at room temperature, e.g. between 15 and 30 C. The ink composition can be maintained as a liquid at a temperature below room temperature, and would gel instantly after contacting a liquid at room temperature.

Alternatively, a thermogelling ink composition can be formulated to have a thermo-inversion point below room temperature, such as between 0 and 10 C. The ink composition can be maintained as a liquid at a temperature below this thermo-inversion temperature, and would gel instantly after contacting a cold liquid at temperatures between 0 and 10 C.

In some embodiments, a temperature of a liquid substrate can be determined. A liquid ink having a concentration of a thermogelling component can be prepared, wherein the concentration is configured so that the liquid ink is gelled when the liquid ink contacts the liquid substrate. For example, the concentration of the liquid ink can be configured so that the liquid ink is gelled at a temperature below or above the temperature of the liquid substrate. The liquid ink can be used to print on the liquid substrate.

In some embodiments, a liquid ink can be prepared, wherein the liquid ink comprises thermo-inversion gelling property at a first temperature. A liquid substrate can be heated or cooled to a temperature above or below the first temperature. The liquid ink can be used to print on the liquid substrate, so that the liquid ink changes phase to gel state when contacting the liquid substrate.

In some embodiments, the present invention discloses a system for printing on a liquid surface of a liquid medium. The system can include a print head, wherein the print head is configured to accept a key color of clear. The print head can be configured to accept one or more colors of cyan, magenta, yellow, and black. The system can also include a platform configured to support a container having the liquid medium, an x-y mechanism, wherein the x-y mechanism is configured to move the print head in x and y directions with respect to the platform, one or more reservoirs coupled to the print head, wherein the reservoirs are configured to supply edible thermogelling phase change liquid inks to the print head.

What is claimed is:

1. A method comprising
forming a membrane on a surface of a liquid;
printing an image on the membrane.

2. A method as in claim 1
wherein the image is printed on top of the membrane.

3. A method as in claim 1
wherein the image is printed penetrating the membrane.

4. A method as in claim 1
wherein the membrane is formed by supplying one or more drops of a second liquid on the surface of the liquid.

5. A method as in claim 1
wherein the membrane comprises a non-mixable and lighter liquid than the liquid.

6. A method as in claim 1
wherein the liquid comprises a water based liquid, and the membrane comprises an oil based liquid.

7. A method as in claim 1
wherein the liquid comprises a water based liquid, and the membrane comprises sulfate ions or selenate ions.

8. A method as in claim 1
wherein the membrane comprises a clear color.

9. A method as in claim 1
wherein the membrane comprises a color of the liquid.

10. A method as in claim 1
wherein the membrane comprises a color configured to emphasize or de-emphasize the image.

11. A method as in claim 1
wherein printing the image comprises using a phase change liquid ink.

12. A method as in claim 1
wherein printing the image comprises using a liquid ink having a thermo-inversion gelling property.

13. A method as in claim 1 further comprising
forming a second membrane on the printed image.

14. A method as in claim 1 further comprising
forming a second membrane on the surface of the liquid outside an external border of the printed image.

15. A method comprising
printing an image on a surface of a liquid using a phase change ink, wherein the phase change ink is in a liquid state before printing, wherein the phase change ink is in a gel state after reaching the liquid surface;
forming a membrane on an area of the liquid surface not covered by the image.

16. A method as in claim 15
wherein the membrane is formed on the area of the liquid surface outside an external border of the image.

17. A method as in claim 15
wherein the membrane is formed on the area of the liquid surface inside an internal border of the image.

18. A method as in claim 15
wherein the membrane is formed by supplying one or more drops of a second liquid on the surface of the liquid.

19. A method comprising
printing an image on a surface of a liquid using a phase change ink, wherein the phase change ink is in a liquid state before printing, wherein the phase change ink is in a gel state after reaching the liquid surface;
forming a membrane on the liquid surface, wherein the membrane covers the image.

20. A method as in claim 19
wherein the membrane also covers an area of the liquid surface not covered by the image.
